(19) United States
(12) Patent Application Publication
(10) Pub. No.: US 2013/0135861 A1
(43) Pub. Date: May 30, 2013

(54) LED ILLUMINATING DEVICE

(71) Applicants: HUI-FANG CHEN, Chu-Nan (TW); YI-CHIEH LIN, Chu-Nan (TW); TE-SHENG CHEN, Chu-Nan (TW)

(72) Inventors: HUI-FANG CHEN, Chu-Nan (TW); YI-CHIEH LIN, Chu-Nan (TW); TE-SHENG CHEN, Chu-Nan (TW)

(73) Assignee: FOXSEMICON INTEGRATED TECHNOLOGY, INC., Chu-Nan (TW)

(21) Appl. No.: 13/304,322

(22) Filed: Nov. 24, 2011

(51) Int. Cl. F21V 5/04; F21S 4/00

(52) U.S. Cl. 362/244; 362/249.02

(57) ABSTRACT

An LED illuminating device for projecting light to a predetermined illuminating plane, includes a supporting pole extending from the illuminating plane, a first LED module arranged on the supporting pole and a second LED module arranged on the supporting pole. The first LED module is for projecting light to a first part of the illuminating plane. The second LED module is for projecting light to a second part of the illuminating plane. The first part of the illuminating plane is adjacent to the supporting pole. The second part of the illuminating plane is adjacent to the first part of the illuminating plane and away from the supporting pole.

### BACKGROUND

1. Technical Field

The present disclosure generally relates to illuminating devices, and particular to an illuminating device employing light emitting diode (LED) lamps.

2. Description of Related Art

With the continuing development of scientific technology and the raise of people's consciousness of energy saving, LEDs have been widely used in the field of lamp due to their small size and high efficiency. However, most LED illuminating devices generally generate non-uniform light intensity distribution, when employed to perform a large area illumination. Accordingly, in the applications of LED illuminating devices, light intensity distribution is always one of major concerns.

Therefore, it is necessary to provide an illuminating device with uniform light intensity distribution.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic view of an LED illuminating device, in accordance with the present disclosure.

FIG. 2 is an assembled view of LED lamps of the LED illuminating device of FIG. 1.

FIG. 3 is an exploded view of the LED lamps of FIG. 2.

FIG. 4 is an isocandela diagram of a first LED module of the LED illuminating device.

FIG. 5 is an isocandela diagram of a second LED module of the LED illuminating device.

FIG. 6 is an isocandela diagram of the LED illuminating device.

### DETAILED DESCRIPTION

Reference will now be made to the drawings to describe the present LED illuminating device, in detail.

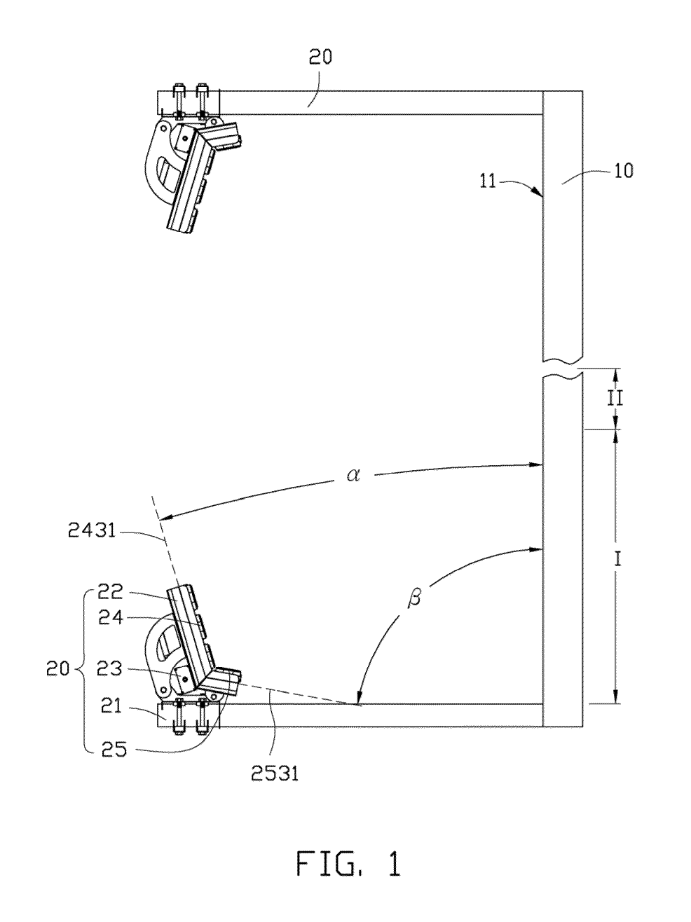

Referring to FIG. 1, an illuminating device according to an exemplary embodiment includes a plurality of LED lamps 20 for illuminating a predetermined object. In this embodiment, the LED lamps 20 are for projecting light to an illuminating plane 11 of a board 10, such as a signboard, a publicity board and so on. The illuminating plane 11, in this embodiment, has an area of 29×8 m².

In this embodiment, the plurality of LED lamps 20 are arranged in two rows. One row of LED lamps 20 is arranged at a top side of the board 10, and the other row of LED lamps 20 is arranged at a bottom side of the board 10. The LED lamps 20 of each row are arranged in equal intervals along a width direction of the board 10. The interval can range from 1.5-2.5 meters, for example 1.8 or 2.2 meters. In this embodiment, the LED lamps 20 of each row are arranged in 2 meters intervals. In an aspect of FIG. 1, only the outmost LED lamp 20 of each row can be seen.

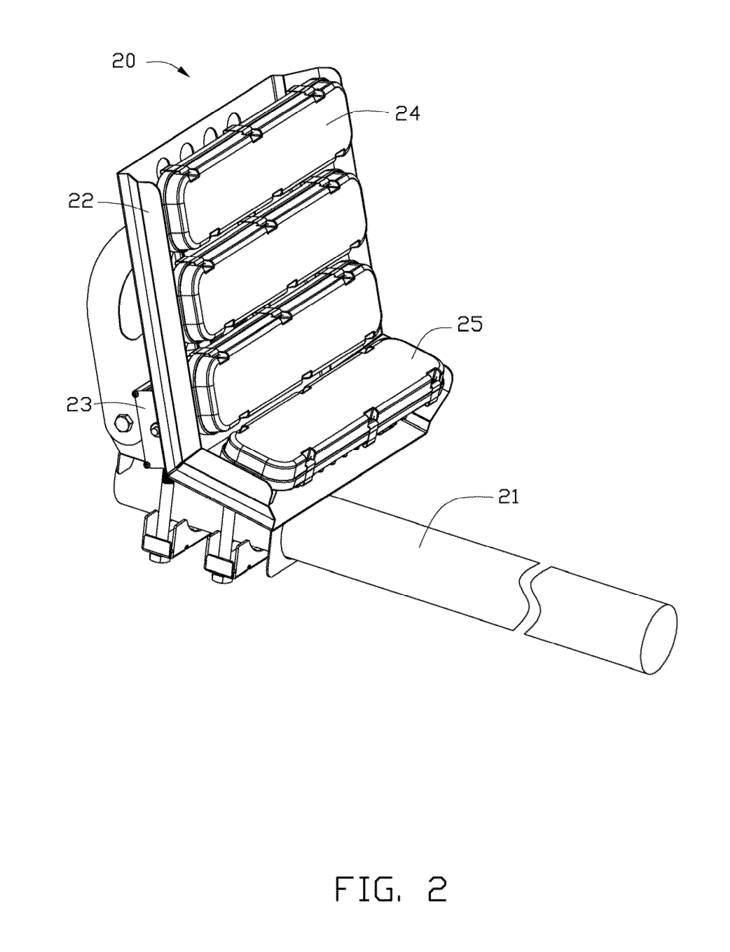

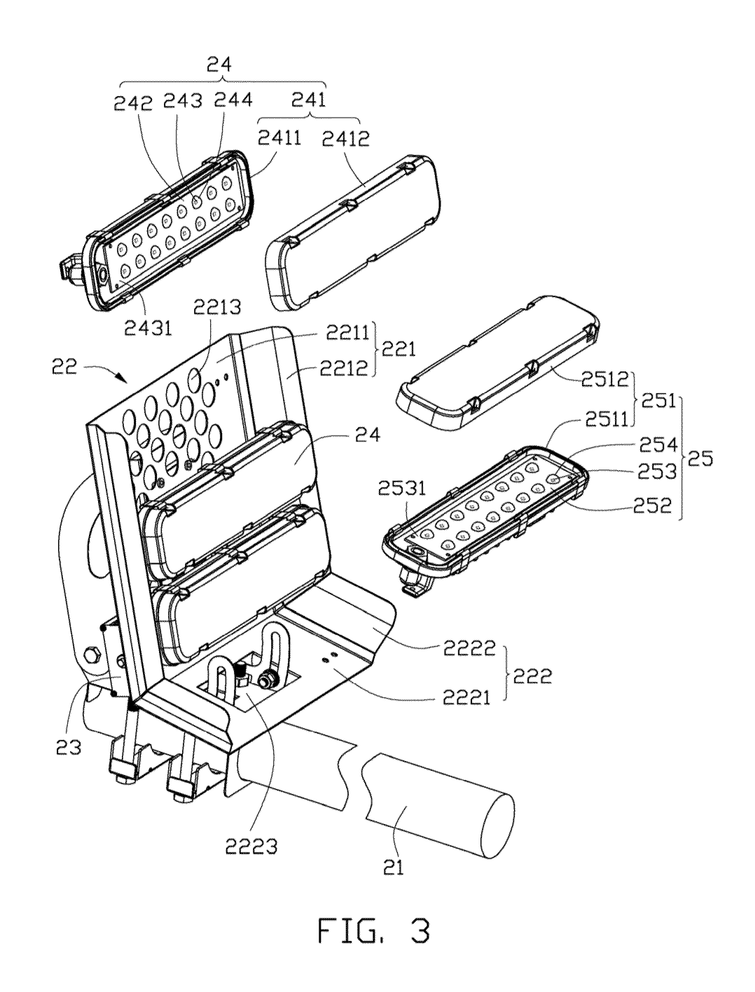

Referring to FIG. 2 and FIG. 3, each LED lamp 20 includes a supporting pole 21, a fixing frame 22 arranged on the supporting pole 21, a driver 23 arranged on the fixing frame 22, a first LED module 24 arranged on the fixing frame 22, and a second LED module 25 arranged on the fixing frame 22.

The supporting pole 21 is a metal column. The supporting pole 21 includes two ends, one of which is fixed on the board 10 and the other is connected to the fixing frame 22. The supporting pole 21 is substantially perpendicular to the board 10. A length of the supporting pole 21 can range from 1-3 meters, for example 1.5 or 2.5 meters. In this embodiment, the supporting pole 21 has a length of 1.8 meters.

The fixing frame 22 is fixed on a distal end of the supporting pole 21, away from the board 10. The fixing frame 22 includes a first board 221 and a second board 222 integrally formed together with the first board 221 as one piece.

The first board 221 sits at one side of the second board 222, and the board 10 sits at another side of the second board 222 opposite to the first board 221. The first board 221 and the second 222 each have a plate like configuration. The first board 221 includes a substrate 2211, and two side plates 2212 extending from two opposite sides of the substrate 2211. The two side plates 2212 each has a wave like configuration consisting of several plates adjoined together side by side. As such, the two side plates 2212 have excellent deformation force for clamping the first LED module 24 tightly. The second board 222 includes a substrate 2221, and two side plates 2222 extending from opposite sides of the substrate 2221. The two side plates 2222 each has a wave like configuration consisting of several plates adjoined together side by side. As such, the two side plates 2222 have excellent deformation force for clamping the second LED module 25 tightly. The extending directions of the two side plates 2222 are parallel to each other, and respectively perpendicular to the substrate 2221. The substrate 2211 and the substrate 2221 cooperatively define an obtuse included angle there between. The substrate 2211 includes a plurality of round through holes 2213 defined therein. The substrate 2221 includes a rectangular through hole 2223 defined therein. The through holes 2213, 2223 are configured for helping heat dissipation and providing passages for power cables.

The driver 23 is for driving the first and second LED modules 24, 25. The driver 23 is fixed on the substrate 2211, and sits at one side of the substrate 2211 opposite to a side of the substrate 2211 where the side plates 2212 sit.

The first LED module 24 is fixed on the substrate 2211 of the first board 221. The first LED module 24 sits between the two opposite side plates 2212. The first LED module 24 includes a cover 241, a circuit board 242, a plurality of LEDs 243 arranged on and electrically connected to the circuit board 242, and a plurality of lenses 244 each arranged above a corresponding LED 243. The cover 241 includes a rear portion 2411 and a front portion 2412 engaged with the rear portion 2411. The rear portion 2411 and the front portion 2412 cooperatively define a chamber receiving the circuit 242, the LEDs 243 and the lenses 244 therein. The LEDs 243 and the lenses 244 face the front portion 2412. The rear portion 2411 can further be equipped with heat dissipating devices (not illustrated) thereon, thereby helping the heat dissipation of the LEDs 243.

The second LED module 25 is fixed on the substrate 2221 of the second board 222, and sits between the two opposite side plates 2222. The first LED module 25 includes a cover 251, a circuit board 252, a plurality of LEDs 253 arranged on and electrically connected to the circuit board 252, and a plurality of lenses 254 each arranged above a corresponding LED 253. The cover 251 includes a rear portion 2511 and a front portion 2512 engaged with the rear portion 2511. The rear portion 2511 and the front portion 2512 cooperatively define a chamber receiving the circuit 252, the LEDs 253 and the lenses 254 therein. The LEDs 253 and the lenses 254 face the front portion 2512. The rear portion 2511 can further be equipped with heat dissipating devices (not illustrated) thereon, thereby helping the heat dissipation of the LEDs 253.

In this embodiment, the circuit board 242 includes an assembling surface 2431 where the LEDs 243 are arranged on, the assembling surface 2431 is parallel to the substrate 2211. The circuit board 252 includes an assembling surface 2531 where the LEDs 253 are arranged on, and the assembling surface 2531 is parallel to the substrate 2221.

The assembling surfaces 2431, 2531 are both inclined to the illuminating plane 11. An included angle α between the assembling surface 2431 and the illuminating surface 11 ranges from 0 to 90 degrees. In this embodiment, the included angle α ranges from 15 to 41.5 degrees. In further detail embodiments, the included angle α can be 22, 30, 35 or 40 degrees. An included angle β between the assembling surface 2531 and the illuminating surface 11 is bigger than the included angle α. The included angle β ranges from 0 to 90 degrees. In this embodiment, the included angle β ranges from 65 to 85 degrees. In further detail embodiments, the included angle β can be 70, 78 or 82 degrees. The assembling surfaces 2431, 2531 cooperatively form an obtuse included angle there between.

Due to that the included angle β is bigger than the included angle α, the first LED module 24 illuminates a first part (labeled with “I”) of the illuminating plane 11 adjacent to the supporting pole 21 and the second LED module 25 illuminates a second part (labeled with “II”) of the illuminating plane 11 adjacent to the first part of the illuminating plane 11 and away from the supporting pole 21.

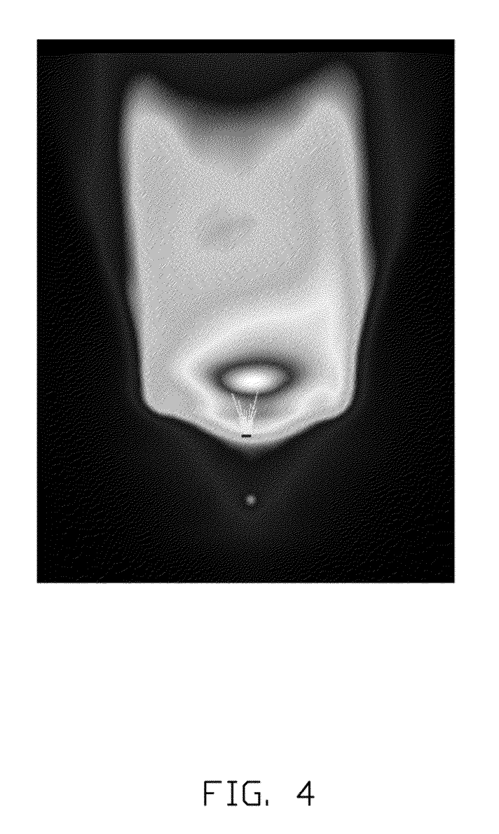

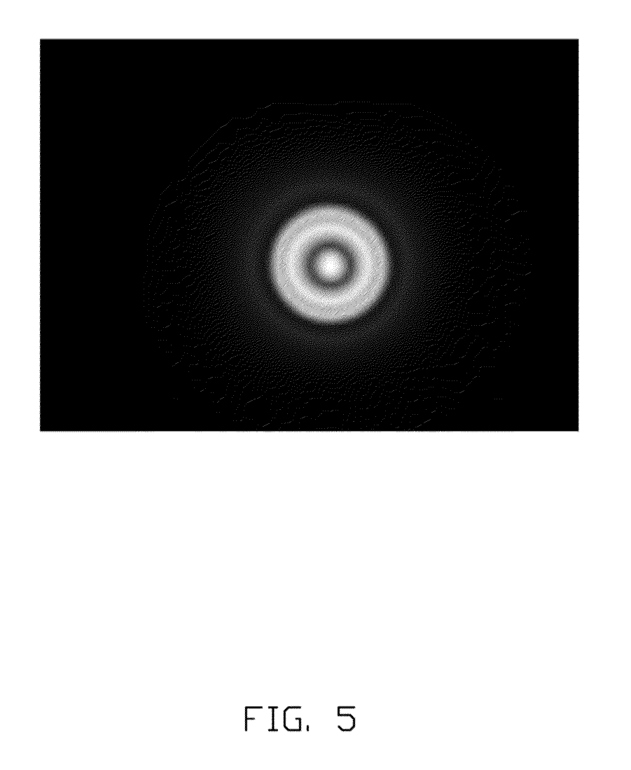

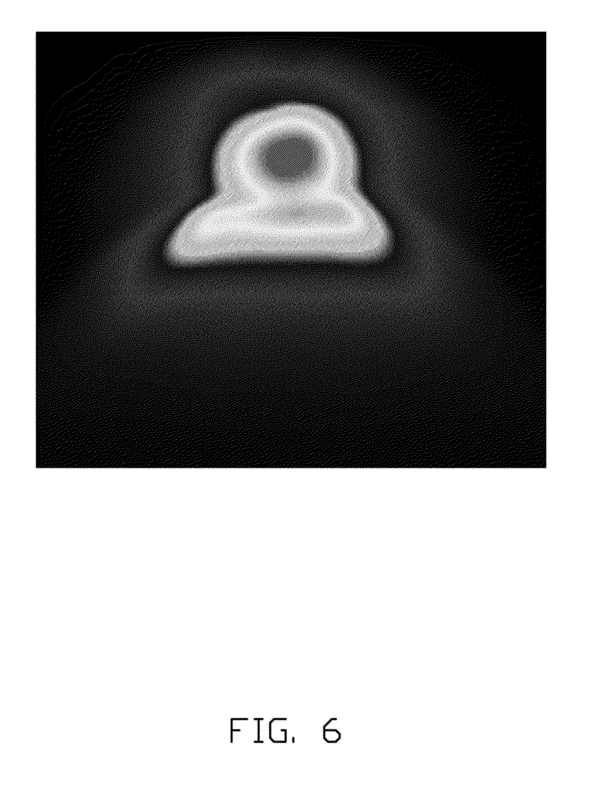

By cooperation of the LEDs 243, 253 and the lenses 244, 254, the first and second LED modules 24, 25 respectively generate a light field with predetermined shapes. The first LED module 24 has a light intensity smaller than that of the LED module 25. In this embodiment, the first LED module 24 has a light spread angle bigger than that of the second LED module 25. That is, light generated by the second LED module 25 is more concentrated than that generated by the first LED module 24. Referring to FIG. 4 and FIG. 5, the first LED module 24 has a big project area but a short project distance, and the second LED module 25 has a small project area but a long project distance. Due to that the illuminance varies inversely with the distance, the illuminance on the first part (labeled with “I”) of the illuminating plane 11 is generally the same as that on the second part (labeled with “II”) of the illuminating plane 11, as illustrated in FIG. 6.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An LED illuminating device for projecting light to a predetermined illuminating plane, the LED illuminating device comprising at least one LED lamp with:
a supporting pole for being fixed to the illuminating plane,
a first LED module arranged on the supporting pole, the first LED module being for projecting light to a first part of the illuminating plane being adjacent to the supporting pole;
a second LED module arranged on the supporting pole, the second LED module being for projecting light to a second part of the illuminating plane away from the supporting pole relative to the first part.

2. The LED illuminating device according claim 1, wherein the first and second LED modules each comprise a circuit board, a plurality of LEDs arranged on the circuit board, and lenses arranged above the plurality of LEDs.

3. The LED illuminating device according claim 1, wherein the first LED module sits in a first plane and the second LED module sits in a second plane, an included angle between the first plane and the illuminating plane being smaller than that between the second plane and the illuminating plane.

4. The LED illuminating device according claim 1, wherein the first LED module is arranged at a distal end of the supporting pole and away from the illuminating plane, and the second LED module is arranged at a position of the supporting pole between the first LED module and the illuminating plane.

5. The LED illuminating device according claim 1, further comprising a fixing frame interconnecting the supporting port with the first and second LED modules, wherein the fixing frame comprises a first board fixing the first LED module and a second board fixing the second LED module.

6. The LED illuminating device according claim 1, wherein the first LED module has a light intensity smaller than that of the second LED module, and the first LED module has a light spread angle bigger than that of the second LED module.

7. An LED lamp for projecting light to a predetermined illuminating plane, comprising:
a supporting pole for fixing the LED lamp to the illuminating plane;
a first LED module arranged on the supporting pole, the first LED module being for projecting light to a first part of the illuminating plane;
a second LED module arranged on the supporting pole, the second LED module being for projecting light to a second part of the illuminating plane;
the first part of the illuminating plane being adjacent to the supporting pole, the second part of the illuminating plane being adjacent to the first part of the illuminating plane and away from the supporting pole.

8. The LED illuminating device according claim 7, wherein the first and second sets of LED lamps each comprise a circuit board, a plurality of LEDs arranged on the circuit board, and a lens arranged above the plurality of LEDs.

9. The LED illuminating device according claim 7, wherein the first LED module sits in a first plane and the second LED module sits in a second plane, an included angle between the first plane and the illuminating plane being smaller than that between the second plane and the illuminating plane.

10. The LED illuminating device according claim 7, wherein the first LED module is arranged at a distal end of the supporting pole and away from the illuminating plane, and the second LED module is arranged at a position of the supporting pole between the first LED module and the illuminating plane.

11. The LED illuminating device according claim 7, further comprising a fixing frame interconnecting the supporting port with the first and second sets of LED lamps, the fixing frame comprising a first board fixing the first LED module and a second board fixing the second LED module.

12. The LED illuminating device according claim 7, wherein the first LED module has a light intensity smaller than that of the second LED module, and the first LED module has a light spread angle bigger than that of the second LED module.

13. An LED lamp for projecting light to a predetermined illuminating plane, the LED lamp comprising:
a supporting pole for fixing the LED lamp to the illuminating plane;
a first LED module arranged on the supporting pole, for projecting light to a first part of the illuminating plane;
a second LED module arranged on the supporting pole, for projecting light to a second part of the illuminating plane, an obtuse angle being defined between the first LED module and the second LED module.

14. The LED illuminating device of claim 13, wherein an first acute angle is defined between the first LED module and the supporting pole, and a second acute angle is defined between the second LED module and the supporting pole.

15. The LED illuminating device of claim 14, wherein the first acute angle ranges from 0 to 90 degrees, and the second acute angle ranges from 65 to 85 degrees.
